(19) United States
(12) Patent Application Publication
(10) Pub. No.: US 2002/0012126 A1
(43) Pub. Date: Jan. 31, 2002

(54) Image processing method and apparatus

(76) Inventor: Hiroaki Nakamura, Kanagawa (JP)

Correspondence Address: SUGHRUE, MION, ZINN, MACPEAK & SEAS, 2100 Pennsylvania Avenue, N.W., Washington, DC, 20037, US

(21) Appl. No.: 09/739,682

(22) Filed: Dec. 20, 2000

(30) Foreign Application Priority Data
Dec. 20, 1999 (JP) 11-360906

(51) Int. Cl. G06K 15/02; H04N 1/407

(52) U.S. Cl. 358/1.9; 358/527; 358/302

(57) ABSTRACT

The image processing method and apparatus set preliminarily a plurality of basic compression characteristics or basic expansion characteristics of image information, select one or more basic compression characteristics or basic expansion characteristics from the plurality of basic compression characteristics or basic expansion characteristics, and compress or expand gradation of the image information using the one or more basic compression characteristics or basic expansion characteristics. Optionally, these method and apparatus analyze the image information, set a processing condition for compressing or expanding the gradation of the image information in accordance with an analysis result and process the image information in accordance with the processing condition. The method and apparatus can perform the dodging processing having the excellent characteristics in a shorter period of processing time than the conventional method and can favorably enhance productivity of print production.

### BACKGROUND OF THE INVENTION

The present invention relates to the field of digital image processing technology applied to digital photoprinters and the like. More specifically, the present invention relates to an image processing method and apparatus which can promptly perform image processing capable of reproducing a high-quality image without a washed-out highlight in a bright portion or a flat (dull) shadow in a dark portion even in a scene in which a subject is taken with backlight or an electronic flash.

Heretofore, the images recorded on photographic films such as negatives and reversals (which are hereunder referred to simply as “films”) have been commonly printed on light-sensitive materials (photographic paper) by means of so-called direct (analog) exposure in which the film image is projected onto the light-sensitive material to expose it.

A new technology has recently been introduced and this is a printer that relies upon digital exposure. Briefly, the image recorded on a film is read photoelectrically, converted to digital signals and subjected to various image processing operations to produce image data for recording purposes; recording light that has been modulated in accordance with the image data is used to scan and expose a light-sensitive material to record a latent image, which is subsequently developed to produce a (finished) print. The printer operating on this principle has been commercialized as a digital photoprinter.

The digital photoprinter basically comprises a scanner (image reading apparatus) for reading an image recorded on the film photoelectrically by projecting a reading light to a film and reading its projection light, an image processing apparatus for carrying out a predetermined image processing on an input image data read by the scanner or another image data supplied by a digital camera or the like so as to obtain an image data for image recording, that is, an exposure condition, a printer (image recording apparatus) for recording the image as a latent image by exposing a light-sensitive material by, for example, scanning with light beam corresponding to the output image data outputted from the image processing apparatus, and a processor (developing apparatus) for carrying out development processing on the light-sensitive material exposed by the printer so as to produce a finished print in which the image is reproduced.

In the digital photoprinter having such features, images are handled as digital image data so that image processing (image adjustment) can be performed by image data processing. Therefore, gradation adjustment, color balance adjustment, color/density adjustment, sharpness processing and the like are favorably performed to produce a high-quality print which has never been realized by a conventional direct exposure. Moreover, in the digital photoprinter, an image taken by the digital camera or the like can be outputted as a print.

As an embodiment of the above-described image processing, included is a case that a dodging effect on a print by direct exposure can also be imparted by processing image data.

Shooting conditions of a photograph are not fixed and there are many cases that a difference between brightness and darkness of an image, namely, a range from the minimum density to the maximum density of the image recorded on the film (difference between minimum and maximum densities equals dynamic range of image density), is very large, as is found in a scene in which the subject is taken with backlight or the electronic flash.

However, a reproducible density range of the light-sensitive material (photographic paper) is narrower than that of the film. Therefore, if a print is produced by exposing (printing) the light-sensitive material with a conventional method using a film image having a wide dynamic range, the image is not appropriately reproduced in some cases. For example, when the print is produced using the film image in which a person is taken with backlight, if exposure is executed such that the person comes out to be a favorable image, a bright portion such as sky will become the washed-out highlight. On the other hand, if exposure is executed such that the sky comes out to be a favorable image, the person will become the flat (dull) shadow.

To cope with the problem, in a conventional printer using an areal exposure, when the print is produced from the film image having such a wide dynamic range, there has heretofore been employed a so-called dodging technique.

The dodging technique is a method of obtaining a print in which an entire density range of the image recorded on the film is appropriately reproduced in such a manner that, for example, if the print is produced from a negative film, an amount of exposure light is increased to a bright portion in which the image tends to become the washed-out highlight and, on the other hand, an amount of exposure light is reduced to a dark portion in which the image tends to become the flat (dull) shadow employing a method of inserting a light-shading plate, an ND (neutral density) filter or the like in an optical path of the exposure light and so forth.

The present applicant has proposed an image processing method in which reproduction of an image imparted with a similar effect in the digital photoprinter or the like to a dodging effect in direct exposure became possible by processing image data and an image processing apparatus using the above-described method (see Unexamined Published Japanese Patent Application (kokai) No.10-13680).

The image processing of interest (hereinafter referred to conveniently as “dodging processing”) performs analysis of the image (image data) supplied by the scanner or the like and, in accordance with an analysis result, compresses (or expands) gradation of the image such that an entire density range recorded on the film is appropriately reproduced whereby dynamic range of the image is compressed (or expanded) so as to be within a range corresponding to an output apparatus.

Specifically, a bright portion (low density portion) and a dark portion (high density portion) are compressed independently in a linear or non-linear manner without changing an intermediate density portion of the image in accordance with the analysis result of the image.

For example, in a system in which image data of the bright portion (high density portion of the negative film: low density portion of a reproduced image) in the photographed scene has a large value, the gradation is compressed by decreasing the image data in the bright portion (image data being large) in which the image tends to be the washed-out highlight and increasing the image data in the dark portion in which the image tends to be the flat (dull) shadow.

Therefore, according to the above-described dodging processing, the image having an extremely wide density range recorded on the film can appropriately be reproduced on the light-sensitive material so that, even if the image has a wide dynamic range as found in a scene in which the subject is taken with backlight or the electronic flash, the print reproducing the high-quality image in which a primary subject such a person's face or the like is appropriately reproduced by means of substantially reducing the washed-out highlight in the bright portion or the flat (dull) shadow in the dark portion can be outputted.

### SUMMARY OF THE INVENTION

An object, therefore, of the present invention is to provide an image processing method and apparatus which can perform the dodging processing having the above-described excellent characteristics in a shorter period of processing time than the conventional method and can favorably enhance productivity of print production, for example, by being utilized in the above-described digital photoprinter.

In order to attain the object described above, the present invention provides an image processing method comprising the steps of: preliminarily setting a plurality of basic compression characteristics or basic expansion characteristics of image information; selecting one or more basic compression characteristics or basic expansion characteristics from the plurality of basic compression characteristics or basic expansion characteristics; and compressing or expanding gradation of the image information using the thus selected one or more basic compression characteristics or basic expansion characteristics.

Preferably, the plurality of basic compression characteristics or basic expansion characteristics are preliminarily set in accordance with at least one of an original type, an original size and an analysis result of the image information.

Preferably, the one or more basic compression characteristics or a plurality of basic expansion characteristics are selected in accordance with at least one of an original type, an original size and an analysis result of the image information.

Preferably, the original type is at least one of a negative film, a reversal film and a black-and-white film, and wherein the original size is at least one of a 135 size, a 240 size and a 120/220 size.

Preferably, the one or more basic compression characteristics or basic expansion characteristics are selected by a manual operation.

Preferably, the basic compression characteristics or basic expansion characteristics are provided as a parameter or a look-up table.

It is preferable that the image processing method further comprises the step of analyzing the image information, wherein the step of compressing or expanding gradation of the image information using the selected one or more basic compression characteristics or basic expansion characteristics comprises the steps of: setting a processing condition for compressing or expanding the gradation of the image information using the selected one or more basic compression characteristics or basic expansion characteristics in accordance with the analysis result; and processing the image information in accordance with the thus set processing condition.

Preferably, the step of compressing or expanding the gradation of the image information using the selected one or more basic compression characteristics or basic expansion characteristics comprises the steps of: setting a processing condition for compressing or expanding the gradation of the image information using the selected one or more basic compression characteristics or basic expansion characteristics by a manual operation; and processing the image information in accordance with the thus set processing condition.

Preferably, the processing condition is set as a look-up table.

The present invention provides an image processing method comprising the steps of: preliminarily setting a plurality of basic compression characteristics or a plurality of basic expansion characteristics; selecting one or more basic compression characteristics or one or more basic expansion characteristics from the plurality of basic compression characteristics or the plurality of basic expansion characteristics; analyzing image information; setting a processing condition for compressing or expanding gradation of the image information using the thus selected one or more basic compression characteristics or the thus selected one or more basic expansion characteristics in accordance with an analysis result obtained by thus analyzing the image information; and processing the image information in accordance with the thus set processing condition.

The present invention provides an image processing method comprising the steps of: preliminarily setting a plurality of basic compression characteristics or a plurality of basic expansion characteristics; selecting one or more basic compression characteristics or one or more basic expansion characteristics from the plurality of basic compression characteristics or the plurality of basic expansion characteristics; setting a processing condition for compressing or expanding gradation of image information using the thus selected one or more basic compression characteristics or the thus selected one or more basic expansion characteristics by an manual operation; and processing the image information in accordance with the thus set processing condition.

In order to attain the object described above, the present invention provides an image processing apparatus comprising: a selecting device for selecting one or more basic compression characteristics or basic expansion characteristics from preliminarily set plurality of basic compression characteristics or basic expansion characteristics for use in compressing or expanding gradation of image information supplied by an image information supply source; and an image processing device for compressing or expanding the gradation of the image information using the one or more basic compression characteristics or basic expansion characteristics selected by the selecting device.

It is preferable that the image processing apparatus further comprises: a setting section for analyzing the image information and setting a processing condition for compressing or expanding the gradation of the image information using the one or more basic compression characteristics or basic expansion characteristics selected by the selecting device in accordance with an analyzing result obtained by thus analyzing the image information, wherein the image processing device processes the image information in accordance with the processing condition set by the setting section.

It is also preferable that the image processing apparatus further comprises: a setting section for setting a processing condition for compressing or expanding the gradation of the image information by a manual operation using the one or more basic compression characteristics or basic expansion characteristics selected by the selecting device, wherein the image processing device processes the image information in accordance with the processing condition set by the setting section.

Preferably, the selecting device selects the one or more basic compression characteristic or basic expansion characteristics in accordance with at least one of an original type of an image as an image information source, an original size of the image as the image information source and an analysis result of the image information.

### BRIEF DESCRIPTION OF THE DRAWINGS

FIG. 1 is a block diagram showing an embodiment of a digital photoprinter utilizing an image processing method and apparatus of the present invention;

FIG. 2 is a block diagram showing an embodiment of the image processing apparatus of the digital photoprinter shown in FIG. 1;

FIG. 3 is a block diagram showing an embodiment of an image processing subsection of the image processing apparatus shown in FIG. 2;

FIG. 4 shows an example of an image density histogram;

FIGS. 5A, 5B and 5C are each an illustration showing an example of a basic compression LUT;

FIGS. 6A, 6B, 6C and 6D are each an illustration showing another example of a basic compression LUT;

FIGS. 7A and 7B are each an illustration showing an example of an LUT for determining a coefficient multiplied to a basic compression LUT;

FIGS. 8A and 8B are each an illustration showing another example of an LUT for determining a coefficient multiplied to a basic compression LUT;

FIG. 9 shows an example of cumulative histogram of density;

FIGS. 10A, 10B and 10C are each an example of a basic expansion LUT; and

FIG. 11 is an illustration showing an example of an LUT for determining a coefficient multiplied to a basic expansion LUT.

### DETAILED DESCRIPTION OF THE INVENTION

Hereinafter, an image processing method and apparatus according to the present invention will now be described in detail with reference to the preferred embodiments shown in the accompanying drawings.

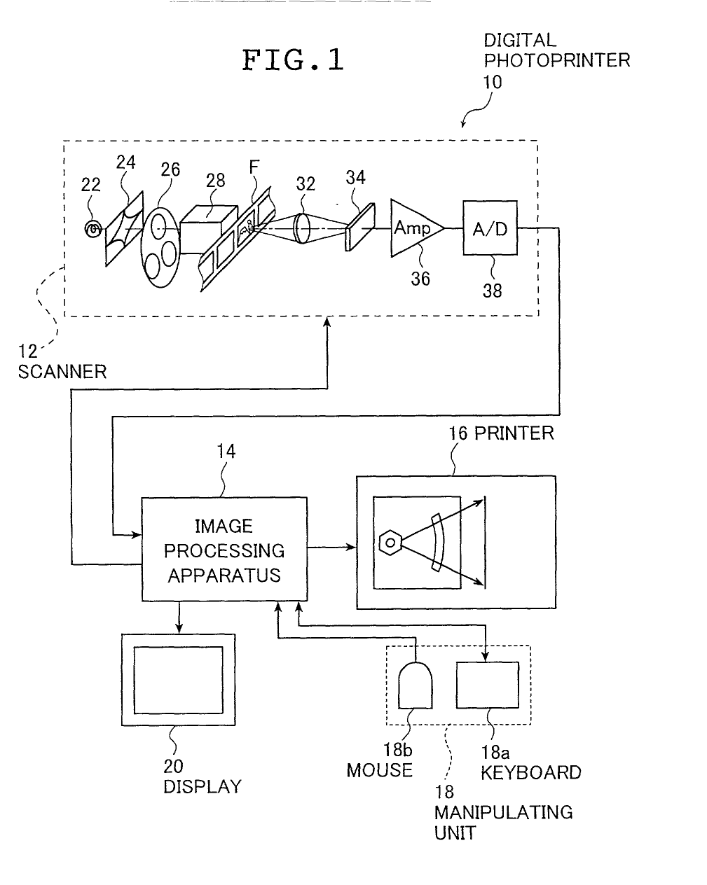

FIG. 1 is a block diagram showing an embodiment of a digital photoprinter utilizing an image processing method and apparatus according to the present invention.

The digital photoprinter (hereinafter referred to simply as “photoprinter”) 10 shown in FIG. 1 basically comprises a scanner (image reading apparatus) 12, an image processing apparatus 14 and a printer 16. Connected to the image processing apparatus 14 are a manipulating unit 18 having a keyboard 18a and a mouse 18b for inputting or setting various conditions, selecting and commanding a specific processing step and entering a command and so forth for effecting color/density correction, as well as a display 20 for representing a simulation image for verification, various manipulative commands and the like.

The scanner 12 is an apparatus with which the images recorded on the film F are read photoelectrically frame by frame. It comprises a white light source 22, a variable diaphragm 24, a color filter plate 26, a diffuser box 28 which diffuses the reading light incident on the film F so that it becomes uniform across the plane of the film F, an imaging lens unit 32, an image sensor 34 which is an area CCD sensor, an amplifier (Amp) 36 and an A/D (analog/digital) converter 38.

In the photoprinter 10, dedicated carriers are available that can be loaded into the body of the scanner 12 in accordance with the type or the size of the film used (e.g. whether it is a film of the Advanced Photo System (APS) or a negative or reversal film of 135 or 120/220 size), the format of the film (e.g. whether it is a film or a slide) or other factor. By replacing one carrier with another, the photoprinter 10 can be adapted to process various kinds of films in various modes. Therefore, the size of the film F (size of an original) which is subjected to reading processing (print production) can be detected by the carrier loaded to the body of the scanner 12.

The images (frames) that are recorded on the film and which are subjected to the necessary procedure for print production are transported to and held in a specified reading position by means of the above-described carriers.

The film F is photoelectrically provided with records of various bar codes such as a DX code, an expanded DX code, an FNS code and the like representing film type and other kinds of information. Moreover, the APS film has a magnetic recording medium formed thereon in which various types of film information such as an ID number, a film type and the like, various types of picture-taking information such as presence or absence of light emission from the electronic flash when taking a picture, date and time of taking the picture and the like are recorded. Therefore, a type of an original can be known from information which the DX code and the magnetic recording medium have.

The respective information as described above are read by the carrier at the time of image reading of the film F and sent to the image processing apparatus 14.

When such a scanner 12 reads the image recorded on the film F, reading light issued from the light source 22 has its quantity adjusted by the variable diaphragm 24 passes through the color filter plate 26 to be adjusted in color and is diffused by passing through the diffuser box 28. The reading light is then incident on the film F held in a predetermined reading position by the carrier and passes therethrough to produce projection light carrying the image recorded on the film F.

The resultant projection light is focused on a light-receiving plane of the image sensor 34 by the focusing lens unit 32 whereupon the image recorded on the film F is read photoelectrically.

An output signal of the image sensor 34 is amplified by the amplifier 36, converted to digital signal by the A/D converter 38 and sent to the image processing apparatus 14.

The color filter plate 26 is a turret having a color filter corresponding to each of R (red), G(green) and B(blue) which is rotated by a rotating device (not shown) to insert each color filter in the optical path of the reading light.

In the illustrated scanner 12, the image recorded on the film F is captured by separating it into three primary colors R, G and B as respective color filters of the color filter plate 26 are sequentially inserted therein and reading the thus separated images into three primary colors one at a time, namely, three times altogether.

In the scanner 12, the image recorded on the film F is captured by two scans, the first being prescan at low resolution and the second being fine scan for obtaining image data corresponding to print output.

On this occasion, the prescan is performed at a preliminarily set prescan reading condition which ensures that the images on all films which the scanner 12 is about to read can be read without saturating the image sensor 34. On the other hand, the fine scan is performed at a fine scan reading condition for each frame, which is set based on the prescanned data so that the image sensor 34 is saturated by a density slightly lower than the minimum density of the image (frame) of interest.

The output signals for prescan and fine scan are essentially of the same data with each other except for resolution and output levels.

It should be noted that an image data supply source which supplies image data to the image processing apparatus according to the present invention is not limited to such a scanner 12.

For example, the illustrated scanner 12 has separated the image into three primary colors using the white light source and the color filter plate; however, the scanner which reads the image by separating it into three primary colors using the light source provided with an LED or the like that individually emits a reading light corresponding to each of three primary colors may be permissible. As another aspect, the scanner which reads the image recorded on the film by slit scanning using CCD line sensors for respective three colors instead of the area CCD sensor may also be permissible.

Moreover, image processing may be performed by receiving image data not only from the scanner which photoelectrically reads the image recorded on the film but also from various image data supply sources which include, for example, an image reading apparatus for reading the image on a reflection material, an image pickup device such as a digital camera or the like, a communication device such as a computer communication network or the like and a recording medium such as a floppy disk or the like.

As described above, the output signal (image data) from the scanner 12 is outputted to the image processing apparatus 14.

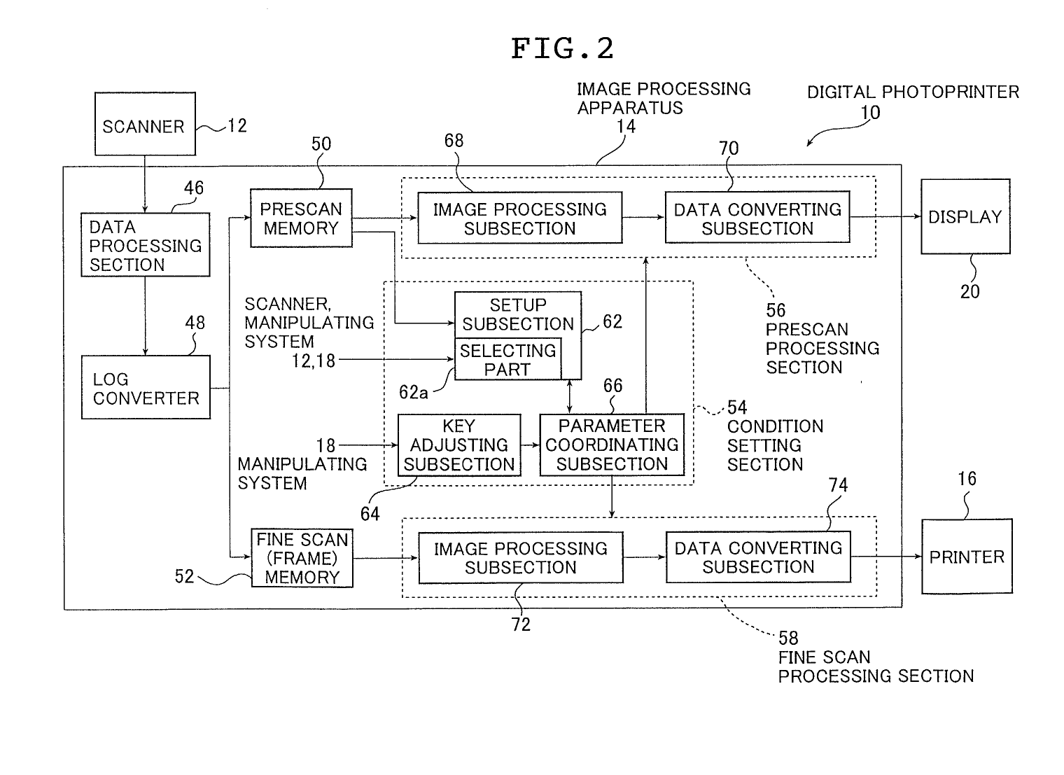

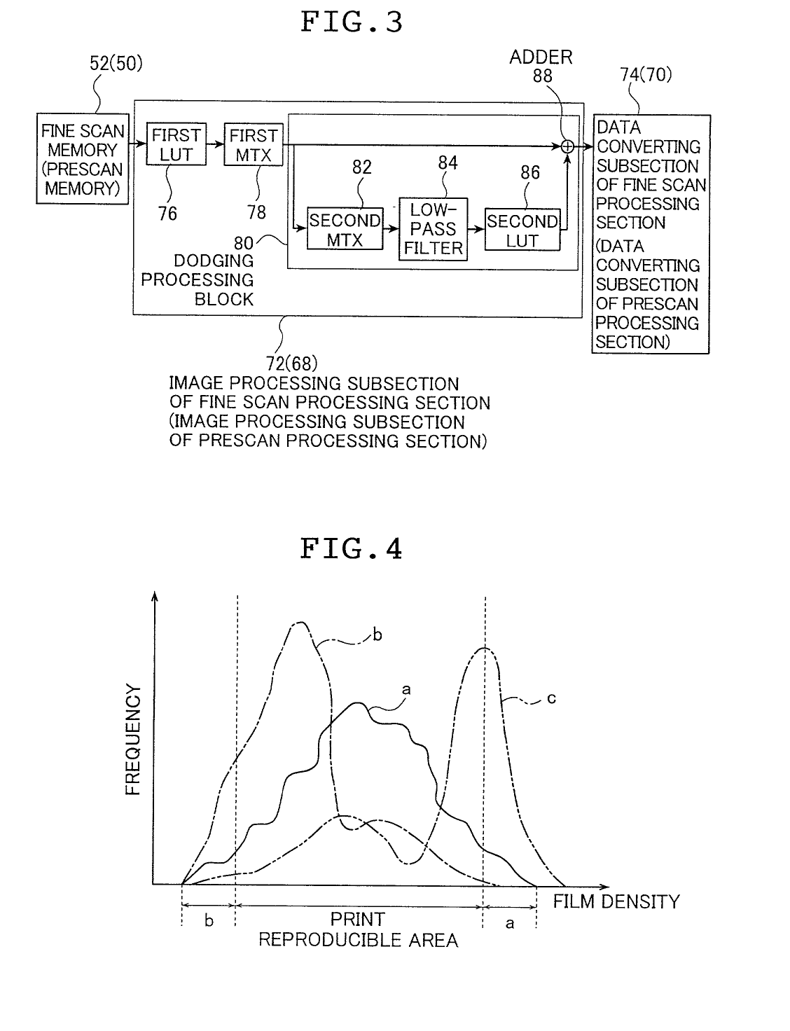

FIG. 2 shows a block diagram of the image processing apparatus 14. The image processing apparatus (hereinafter referred to simply as “processing apparatus”) 14, as shown in FIG. 2, comprises a data processing section 46, a log converter 48, a prescan (frame) memory 50, a fine scan (frame) memory 52, a condition setting section 54, a prescan processing section 56 and a fine scan processing section 58.

FIG. 2 mainly shows sites relating to the image processing. However, the processing apparatus 14 also controls and manages overall operation of the photoprinter 10 and, in addition to the sites shown in FIG. 2, the processing apparatus 14 includes a CPU for controlling the overall operation, a memory or the like for storing information necessary for operation or the like of the photoprinter 10. The manipulating unit 18 and the display 20 are connected to respective sites via this CPU (CPU bus) and the like.

Respective output signals for red, green and blue outputted from the scanner 12 are subjected to predetermined processing for DC offset correction, darkness correction, shading correction and the like by the data processing section 46 and then logarithmically converted to digital image (density) data (by such as an LUT (look-up table) or the like) in the log converter 48. Prescanned (image) data is stored in the prescan memory 50 and fine scanned (image) data is stored in the fine scan memory 52.

The condition setting section 54 for setting an image processing condition of each image (frame) in the prescan processing section 56 (its image processing subsection 68) and the fine scan processing section 58 (its image processing subsection 72) comprises a setup subsection 62, a key adjusting subsection 64 and a parameter coordinating subsection 66.

The setup subsection 62 is a site in which the image processing condition for each frame is set by performing an image analysis using the prescanned data (automatic setup operation processing).

Specifically, based on the prescanned data, the setup subsection 62 constructs an image density histogram, calculates image characteristic quantities such as an LATD (large area transmission density), specified % points of frequencies of the image density histogram such as maximum and minimum densities and the like, an average density and the like and then, in accordance with the density histogram or the image characteristic quantities, calculates a reading condition for the fine scan and image processing conditions such as various types of LUTs, matrix operational formulas or the like in the image processing subsections 68 and 72 by a known method such as a matrix operation, an image processing algorithm or the like.

Moreover, the setup subsection 62 has a selecting part 62a that comprises a memory therein in which a plurality of preset basic compression characteristics and a plurality of preset basic expansion characteristics are stored. The selecting part 62a selects one or more basic compression (expansion) characteristics from the plurality of basic compression characteristics and the plurality of basic expansion characteristics thus stored in the built-in memory in accordance with at least one of the type of the original, the size of the original and an result of the image analysis (automatic setup operation). The setup subsection 62 sets a dodging processing condition using the basic compression (expansion) characteristics selected by the selecting part 62a. Namely, the setup subsection 62 is a major portion composing the image processing apparatus executing the image processing method according to the present invention.

This point will be discussed later in detail.

The key adjusting subsection 64 calculates an adjusting quantity for the image in accordance with various instructions for adjustment inputted by various adjusting keys set on the keyboard 18a such as a density adjusting key, an adjusting key for each color of C (cyan), M (magenta) and Y (yellow), a gradation (γ: gamma) adjusting key, a bright portion adjusting key, a dark portion adjusting key, a sharpness adjusting key, a saturation adjusting key and the like, and the mouse 18b and then supplies the thus calculated adjusting quantity to the parameter coordinating subsection 66.

The parameter coordinating subsection 66 receives the image processing condition set by the setup subsection 62 and sets the thus received image processing condition at the image processing subsection 68 in the prescan processing section 56 and the image processing subsection 72 in the fine scan processing section 58. The parameter coordinating subsection 66 further performs an adjustment (correction) of the image processing condition set in each of the processing section in accordance with the adjusting quantity of the image calculated by the key adjusting subsection 64, creation of a correction condition with which such adjustment (correction) is carried out and setting of the thus created correction condition in each of the processing section.

In the illustrated processing apparatus, the prescanned data stored in the prescan memory 50 and the fine scanned data stored in the fine scan memory 52 are basically processed in the prescan processing section 56 and in the fine scan processing section 58, respectively.

The prescan processing section 56 comprises the image processing subsection 68 and a data converting subsection 70. On the other hand, the fine scan processing section 58 comprises the image processing subsection 72 and a data converting subsection 74.

The image processing subsection 68 of the prescan processing section 56 and the image processing subsection 72 of the fine scan processing section 58 have basically the same construction except that the pixel densities of image data to be processed are different from each other and carry out the same processing.

Therefore, the image processing subsection 72 of the fine scan processing section 58 is explained below as a representative example.

The image processing section 72 (68) comprises a first LUT 76, a first matrix calculator (hereinafter referred to simply as “MTX”) 78 and a dodging processing block 80.

As described above, the image processing condition in each of the above-described processing sites is set in the condition setting section 54.

The first LUT 76 reads out the image data stored in the fine scan memory 52 (prescan memory 50) and performs the gray balance (color balance) correction, density correction and gradation correction. It is composed of LUTs which are connected to each other in a cascade fashion to perform respective corrections.

The first MTX 78 performs color correction of the image (image data) processed by the first LUT 76. That is, the first MTX 78 performs a matrix calculation set in accordance with a spectral characteristic of the film F, a spectral characteristic of the light-sensitive material (photographic paper), a characteristic of development processing and the like so that the image to be outputted as a print is finished in an appropriate color.

The dodging processing block 80 is a site which performs digital dodging processing (imparts a digital dodging effect similar to that of a print produced by direct exposure by means of image data processing); it comprises a second MTX 82, a low-pass filter (LPF) 84, a second LUT 86 and an adder 88.

When the dodging processing is performed, the image data processed by the first MTX 78 is supplied to the second MTX 82 and the adder 88. On the other hand, when the dodging processing is not performed, the first MTX 78 and the data converting subsection 74 (70) are directly connected to each other via a bypass and the image data is supplied from the first MTX 78 to the data converting subsection 74.

The second MTX 82 receives the image data of R, G and B images sent from the first MTX 78 to create the image data (luminance image data) of luminance images of the images of interest.

A method of creating the luminance image data is not limited to a particular way, but a method of using a value of one-third of the mean value of each of the RGB image data, a method of converting color image data into the luminance image data using a YIQ base and the like are exemplified. For example, a method of creating the luminance image data by calculating only a Y component of the YIQ base from the red, green and blue image data by a formula, Y=0.3R+0.59G+0.11B, is exemplified.

The LPF 84 two-dimensionally shades off the luminance image by processing the luminance image data created by the second MTX 82 and taking out a low frequency component therefrom thereby obtaining an unsharp image data of a read-out image.

The LPF 84 is used for compressing the image gradation and, when the image gradation is expanded to the contrary, the second MTX 82 and the second LUT 86 are connected to each other via a bypass whereby the luminance image data created by the second MTX is sent to the second LUT.

As the LPF 84, a finite impulse response (FIR) type low-pass filter which is ordinarily used for creating an unsharp image may be used; however, preferably, an infinite impulse response (IIR) type low-pass filter is used because it can create unsharp image data in which the image is made unsharp to a great extent in a small circuit.

Since the prescanned image data and the fine scanned image data are different from each other in resolution of the images, if they are processed by the same low-pass filter, the images to be reproduced by the display 20 and the printer 16 will be different from each other. Accordingly, it is necessary to change a frequency characteristic of the LPF 84 in accordance with the resolution each of the prescanned data and the fine scanned data.

Specifically, an amount of shading-off of the unsharp image data used for representation on the display 20 may be reduced by a ratio of resolution. Namely, when the ratio of resolution is represented by m; the cut-off frequency of the prescanned data is represented by fc(p); the cut-off frequency of the fine scanned data is represented by fc(f), the low-pass filter may be designed to satisfy the following formula:

fc(p)≈mfc(f)

The unsharp image data created by the LPF 84 (or the luminance image data created by the second MTX) is processed by a gradation compressing (expanding) LUT in the second LUT 86.

As described above, the image density range which can be recorded on the film F is ordinarily wider than the reproducible image density range in the print and, for example, in the scene in which the subject is taken with backlight or the electronic flash, the image having the density range which greatly exceeds the reproducible area in the print may be recorded in some cases.

FIG. 4 shows an example of an image density histogram (film density) created from the image data of a read-out negative film by the setup subsection 62.

When the reproducible area in the print is located within the region of image density shown by broken lines in FIG. 4, all the pixels of the images shown by a to c can not be reproduced in the print. That is, a high image density portion outside of the reproducible area (where the intensity of read-out signals is weak: where the image data is large), namely, the bright portion in the print (recorded scene) will become the washed-out highlight, while a low image density portion outside of the reproducible area, namely, the dark portion in the print will become the flat (dull) shadow. To obtain the image in which all the image data is reproduced, a range from the maximum density to the minimum density of the image (dynamic range of the image density) must be compressed so that it corresponds to the reproducible area in the print. That is, it is necessary to process the image data in such a manner that the dynamic range is compressed by compressing the gradation of the image (image data) so as to allow it to correspond to the reproducible area in the print whereupon an effect similar to that obtained by the dodging technique using ordinary direct exposure is achieved.

When the image of the film F serving as the original is over exposed, there is a tendency that the image comes to have high density as a whole thereby producing the image the bright portion of which is dull in the print. On the other hand, when the image is under-exposed, there is a tendency that the image comes to have low density as a whole thereby producing the image the dark portion of which is dull in the print.

Therefore, in order to obtain a high-quality image on this occasion, it is necessary to enhance the contrast by increasing an inclination of a gradation curve. Specifically, when the image is over-exposed, it is necessary to increase the inclination of the gradation curve in the high density portion (bright portion in the print) within the reproducible area in the print; when the image is under-exposed, it is necessary to increase the inclination of gradation curve in the low density portion (dark portion in the print) within the reproducible area in the print. In other words, when the under-/over-exposed image is corrected, it is necessary to expand the gradation to the contrary.

In the illustration shown in FIG. 4, the image data comes to correspond to a density reproducible area in the print by non-linearly compressing or expanding the gradation of primary image data by means of adding the above-described unsharp image data (luminance image data) processed by the gradation compression (expansion) LUT of the second LUT 86 to the primary image data processed by the first MTX 78. In this way, the gradation, the density or the dynamic range of the bright/dark portion of the image data to be outputted is appropriately set whereby, even in the scene in which the subject is taken with backlight, the electronic flash or the like, an appropriate print having a high-quality image therein can be outputted consistently.

Namely, the gradation compression (expansion) LUT of the second LUT 86 is an LUT for processing the above-described unsharp image data (luminance image data) to obtain image data to be used for processing the primary image data such that the gradation thereof or the like is appropriately set.

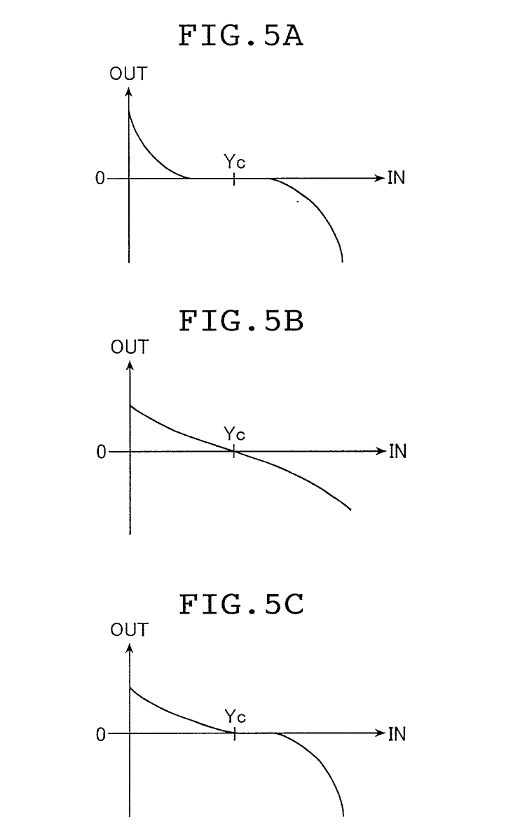

As an example, the selecting part 62a of the setup subsection 62 stores three basic compression LUTs, as shown in FIGS. 5A to 5C, which show basic compression characteristics. Yc in each of FIGS. 5A to 5C represents the center of each density, for example, about 0.8 by the density D.

The basic compression LUT shown in FIG. 5A denotes compression characteristics which put emphasis on appropriate reproduction of the bright and dark portions. Namely, both the washed-out highlight in the bright portion and the flat (dull) shadow in the dark portion are decreased by compressing the gradation by means of intensively compressing the density range which greatly exceeds the reproducible area in the print without compressing the intermediate gradation whereby density ranges in both portions can favorably be reproduced.

The basic compression LUT shown in FIG. 5B denotes compression characteristics which compress the entire area from the bright portion to the dark portion. According to this basic compression LUT, the gradation is compressed such that the entire area thereof comes close to be of an intermediate gradation thereby enhancing a ratio of appropriate images (acceptance). Namely, this basic compression LUT enhances the ratio of prints which can be outputted (verification OK) only by means of an automatic correction by the processing apparatus 14 so that it serves as a basic compression LUT for enhancing productivity in a lab shop and the like.

The basic compression LUT shown in FIG. 5C denotes compression characteristics which compress the range in the bright portion that greatly exceeds the reproducible area in the print and the entire range in the dark portion. Further, in place of the above LUT or in addition to the above LUT, another basic compression LUT which has compression characteristics adverse to those of the LUT shown in 5C may be stored.

As an example, the selecting part 62a selects one or a plurality of basic compression LUTs setting the type of the original as a parameter, for example, in accordance with the type of the film F, that is, a negative, reversal or black-and-white film. Namely, in the above example, one or more basic compression characteristics can be defined in accordance with each type of the original. The type of the original may be obtained by the bar code such as the DX code or the like, magnetic information of the Advanced Photo System (APS) read by the carrier of the scanner or an input by the operator.

In the above-described example, for example, if the film F is the negative film, the selecting part 62a selects the basic compression LUT shown in FIG. 5B and, if the film F is the reversal film or the black-and-white film, it selects the basic compression LUT shown in FIG. 5A.

Further, as a selection parameter for the basic compression LUT, the size of the original such as 135, 240 or 120/220 size in the case of the film F can favorably be utilized. Namely, in the above-described example, one or more basic compression LUTs can be defined in accordance with the size of the original. The size of the original may be obtained by the bar-code such as the DX code or the like or the magnetic information of the APS read by the carrier loaded in the scanner or input by the operator.

In the above-described example, for example, if the film F is of the 135 or 240 size, the selecting part 62a selects the basic compression LUT shown in 5B and, if the film is of the 120/220 size, it selects the basic compression LUT shown in 5A.

As the selection parameter for the basic compression LUT, the image analysis result or selection/setting by the operator is also favorable.

When the result of image analysis is used, a ratio between regions of the bright portion and dark portion, an image contrast and the like can be used as an analysis result. For example, it is possible that the image in which the region of the bright portion is dominant is an image in a scene in which a subject is taken with backlight; therefore, basic compression characteristics shown in FIG. 5C are selected so that the gradation compression is performed positively on the portion having a darker density than intermediate. To the contrary, for the image having an extremely large contrast, the basic compression characteristics shown in FIG. 5(B) are selected so that the gradation can be compressed in an overall manner.

Namely, as a selection method of the basic compression LUT based on the image analysis result, for example, when the image density histogram information is used, if the ratio of the image bright and dark portions is large and, moreover, if difference of densities between the bright and dark portions is large, then the basic compression LUT shown in 5A is selected; if the ratio of the image bright portion is large and, moreover, if the density in the bright portion is extremely large, then the basic compression LUT shown in 5C is selected; and in the other cases than the above-described cases, the basic compression LUT shown in 5B is selected.

In this occasion, the analysis results of the image to be used for selection of the basic compression LUT, for example, the ratio, densities, difference of densities or the like of the image bright and dark portions may appropriately be set in accordance with apparatus characteristics of the photoprinter 10 or the like.

The basic compression LUTs shown in FIGS. 5A to 5C correspond to the compression of the dynamic range across the entire density range from the bright portion to the black portion. However, the present invention is not limited to the above example but the selecting part 62a may independently have a plurality of basic compression LUTs in each of the bright and dark portions and select a basic compression LUT in each of the bright and dark portions in accordance with a selection parameter such as the type of the original, the size of the original or the like so that the thus selected basic compression LUTs may be set as the basic compression LUTs which correspond to the compression of the dynamic range across the entire density range.

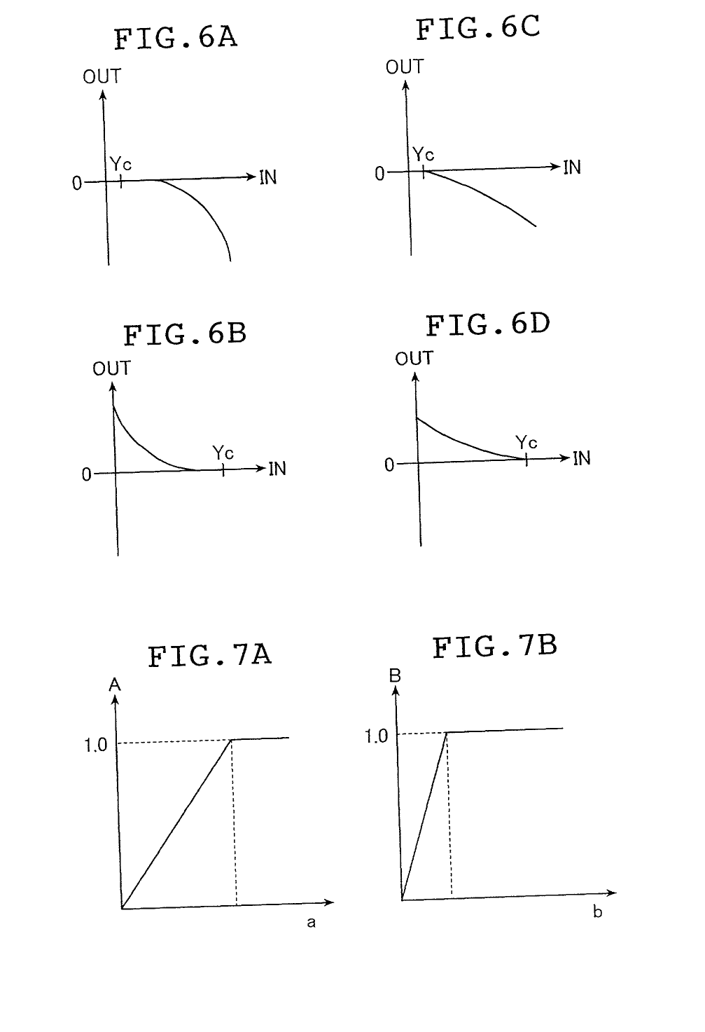

FIGS. 6A to 6D each shows an example of the above-described aspect.

Among examples shown in FIGS. 6A to 6D, FIGS. 6A and 6C show examples which correspond to compression in the bright portion; FIGS. 6B and 6D show examples which correspond to compression in the dark portion. The basic compression LUTs shown in FIGS. 6A to 6D are illustrations in which the basic compression LUTs shown in FIGS. 5A and 5B have been divided into the bright and dark portion sides by the point of Yc.

Setting, for example, at least one of the type of the original, size of the original, the image analysis result and selection/setting by the operator as a parameter and, in accordance with the thus set parameter, the selecting part 62a of the setup subsection 62 selects one or more basic compression LUTs shown in FIGS. 6A and 6C which compress the bright portion and one or more basic compression LUTs shown in 6B and 6D which compress the dark portion and add the thus selected basic compression LUTs with each other to produce a basic compression LUT which corresponds to the entire density range.

It should be noted that, in the image processing apparatus according to the present invention, the basic compression LUT to be selected is not limited to one but a plurality of the basic compression LUTs are permissible as described above. On this occasion, for example, selected basic compression LUTs may be used by synthesizing them with each other or connecting them to each other in a cascade fashion.

Moreover, the parameter to be used for selecting the basic compression LUT is not limited to one, but a plurality of parameters may be used for selecting a basic characteristic LUT.

Further, it should be noted that the selection method of the basic compression LUT corresponding to the parameter is not limited in any particular way, but the selecting part 62a may store it as a predetermined file or otherwise the setup subsection 62 may appropriately determine it in accordance with a selection parameter.

The setup subsection 62 automatically sets up the dodging processing condition in accordance with the image analysis using the basic compression LUT thus selected by the selecting part 62a. It should be noted that the setup subsection 62 may of course set the basic compression LUT which the selecting part 62a thereof has selected as a dodging processing condition without adding any change thereto.

In the present invention, a plurality of the basic compression LUTs or basic expansion LUTs (compression or expansion characteristics) have previously been set by the above-described method and then the basic compression LUT or the like is selected in accordance with the type of the original, the size of the original, the image analysis result, selection/setting by the operator or the like thereby setting the compression (expansion) LUT of the dodging processing (dodging processing condition) using the thus selected basic compression LUT or the like. In doing this way, even the scene in which the subject is taken with backlight or the electronic flash can be subjected more promptly than in a conventional way to dodging processing which substantially decreases the washed-out highlight in the bright portion or the flat (dull) shadow in the dark portion whereupon, for example, productivity of prints in the photoprinter 10 can favorably be enhanced.

Conveniently, when the Yc which is the intermediate density is set as a border, the compression of the bright portion side is set as g_{light} and the compression of the dark portion side is set as g_{dark}, then the basic compression LUT is shown by the following formula:

The basic compression LUT=g_{light}+g_{dark}

In the illustration, the compression ratio fₐᵤₜₒ (gradation compression LUT which will be hereinafter referred to simply as “compression LUT”) of the dodging processing which is automatically set up by the setup subsection 62 is determined by the following formula using the selected basic compression LUT:

fₐᵤₜₒ=A×g_{light}+B×g_{dark}

In the above formula, coefficients A and B are set within the ranges of 0≦A≦1, 0≦B≦1, respectively, and they are appropriately determined in accordance with image conditions, specifically, the image characteristics such as the frequencies of both bright and dark portions, the maximum and minimum image densities of the image density histogram, an average image density or the like.

That is, in the case of the image of the histogram b shown by the dot-dash-line in FIG. 4, since the dark portion (low density on the film) has a high frequency, it can be determined that the image is recorded using the electronic flash or the like at night. In this type of the image, the compression ratio on the bright portion side is set to have a large value, that is, the coefficient A multiplied to g_{light} is set to have a large value. When the image is recorded using the electronic flash or the like at night, since a primary subject such as a person or the like is ordinarily located on the bright portion side of the histogram (a high density side on the film), the image is likely to turn bright, washed-out highlight. However, the above processing can make the primary subject have an appropriate image density (brightness).

On the contrary, in the image of the histogram c shown by the two-dot-and-dash-line in FIG. 4, since the bright portion has a high frequency, it can be determined that the image of a snow scene or a scene in which the subject is taken with backlight is recorded. In this type of the image, the compression ratio on a dark portion side is set to have a large value, that is, the coefficient B multiplied to g_{dark} is set to a large value. In the scene in which the subject is taken with backlight or the like, since a primary subject is ordinarily located on the dark portion side of the histogram, the image is likely to turn dark. However, the above processing can turn the primary subject to bright and produce a high-quality image.

When the maximum and minimum densities of the image density histogram are greatly dislocated from the print reproducible area, the compression ratio must be increased at both the bright and dark portions in order to appropriately reproduce all the images.

As a method of determining the coefficients A and B, there is illustrated, for example, a method of preparing an LUT as shown in FIG. 7A which shows the relationship between the image density region a dislocated to the bright portion side and the coefficient A and another LUT as shown in FIG. 7B which shows the relationship between the image density region b dislocated to the dark portion side and the coefficient B and determining the coefficients A and B using the thus prepared LUTs. In the above method, a represents an extent of an image density area which is dislocated from the print reproducible area to the bright portion side; b represents an extent of the image density area which is dislocated from the print reproducible area to the dark portion side in the image density histogram shown in FIG. 4 (both regions of a and b are illustrated in the histogram a in FIG. 4).

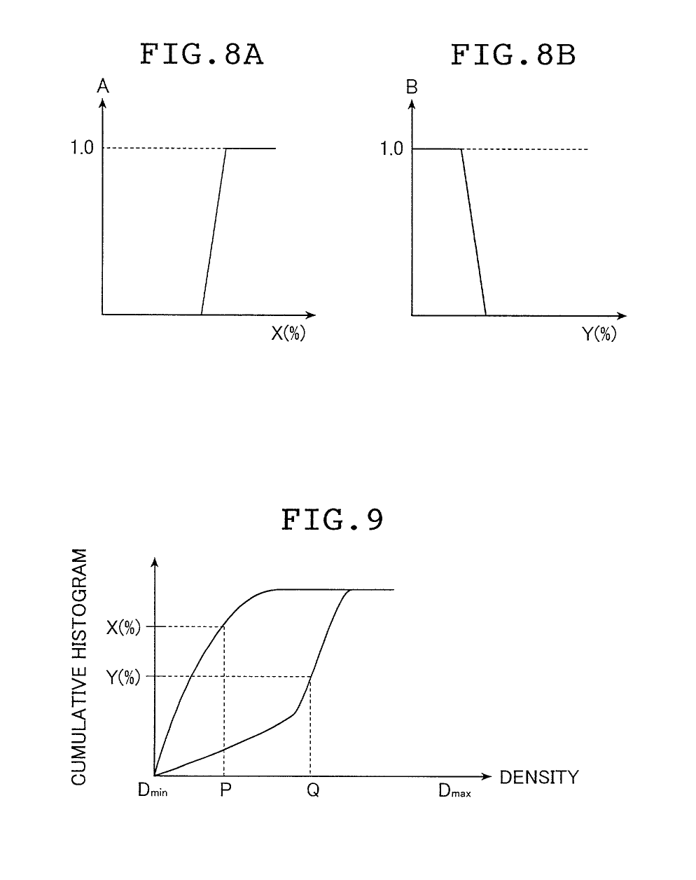

Otherwise, there is also illustrated a method of determining the coefficient A and the coefficient B. According to the method, there are prepared an LUT showing the relationship between the frequency on the dark portion side (cumulative percent=X%) and the coefficient A as shown in FIG. 8A and another LUT showing the relationship between the frequency on the bright portion side (cumulative percent=Y%) and the coefficient B as shown in FIG. 8B. Further, a cumulative histogram of the image density as shown in FIG. 9 is prepared from the image density histogram and respective cumulative percentages at the dark and bright portions are calculated from a print reproduction limit P on the dark portion side and a print reproduction limit Q on the bright portion side using the thus prepared cumulative histogram thereby determining the coefficients A and B using the LUTs shown in FIGS. 7A and 7B.

Other favorably exemplified methods than the above-described methods include a method of determining the coefficients A and B by first calculating coefficients A and B from each of the LUTs shown in FIGS. 6A to 6D and FIGS. 7A and 7B and then averaging the thus calculated respective coefficients As and coefficients Bs separately and a method of determining the coefficients A and B by first calculating coefficients As and Bs in the same way as in the above-described method and then selecting coefficients A and B each of which has a larger value than the other coefficients As and Bs.

Furthermore, the coefficients A and B may be determined by selecting which LUT to use on the basis of the histogram.

As described above, with respect to cases where the image recorded on the film F is over-exposed or under-exposed, when the film image is under-exposed, the inclination of the gradation curve in the dark portion is increased, whereas when it is over-exposed, the inclination of the gradation curve in the bright portion is increased, to correct the above states. That is, when the image is under-exposed or over-exposed, the setup subsection 62 sets the gradation expansion LUT (hereinafter, referred to simply as “expansion LUT”) and expands the gradation of the image thereby expanding the dynamic range on the contrary.

It should be noted that a method of discriminating between the image is under-exposed and the image is over-exposed is not particularly limited but any known method of discrimination based on the image characteristic quantity, average image density, maximum image density, minimum image density or the like obtained from the image density histogram may be used.

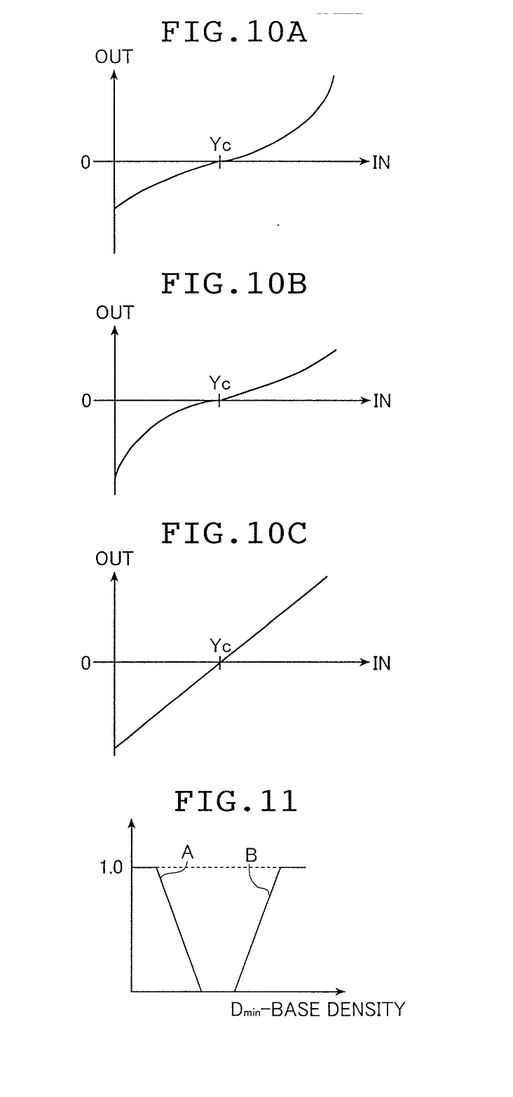

In the selecting part 62a of the setup subsection 62, as an example, basic expansion LUTs as shown in FIGS. 10A to 10C are stored.

The selecting part 62a sets, for example, one or more of the type of the original, the size of the original, the image analysis result and the selection/setting by the operator as parameters and selects at least one of the basic expansion LUTs shown in FIGS. 10A to 10C in accordance with the thus set parameters.

As an example, in the case of over-exposure, the basic expansion LUT shown in FIG. 10A is selected; in the case of under-exposure, the basic expansion LUT shown in 10B is selected; in the case of ultra-under-exposure or ultra-over-exposure, the basic expansion LUT shown in 10C is selected.

Discrimination between the (ultra-) under-exposure and (ultra-) over-exposure to be used when the basic expansion LUT is selected may appropriately be set in accordance with the apparatus characteristics of the photoprinter 10 or the like.

When the expansion of the bright portion for primarily correcting the over-exposure is represented by qₒᵥₑᵣ and the expansion of the dark portion for primarily correcting the under-exposure is represented by q_{under}, the basic expansion LUT is shown, as in the same way as in the compression of the above-described gradation, in the following formula:

The basic expansion LUT=qₒᵥₑᵣ+q_{under}

Also, the expansion ratio qₐᵤₜₒ (expansion LUT) of the dodging processing which the setup subsection 62 automatically sets up is determined by the following formula by means of using the selected basic expansion LUT:

qₐᵤₜₒ=A×q_{under}+B×qₒᵥₑᵣ

In the above formula, the coefficients A and B are set within the ranges of 0≦A≦1 and 0≦B≦1, respectively, and they are appropriately determined in accordance with the states of the image, specifically, the image characteristic quantities such as the difference between the minimum density of the image density histogram and the film base density, frequencies of the bright and dark portions, the maximum and minimum densities of the density histogram, the average density and the like.

A method is illustrated in which a table showing the coefficients A and B with respect to a difference between the minimum density (Dₘᵢₙ) of the image density histogram and the film base density is preliminarily created, for example, as shown in FIG. 11, and then the coefficients A and B are determined using the thus created table.

In the image processing apparatus according to the present invention, the compression ratio or the expansion ratio by the dodging processing is not limited to the type which the setup subsection 62 automatically sets up but the compression LUT or the expansion LUT may be created by adding an adjustment in accordance with operator's manipulation of the keyboard (for example, the above-described gradation adjustment key, bright portion adjustment key or dark portion adjustment key) to the above-described compression ratio fₐᵤₜₒ or expansion ratio qₐᵤₜₒ by the operator. The adjustment of compression ratio or the expansion ratio by the operator is described in commonly assigned Unexamined Published Japanese Patent Application (kokai) No. 10-13680 in detail.

It should be noted that the image processing apparatus according to the present invention is not limited to the type which performs both compression and expansion of the gradation but, for example, the apparatus which stores a plurality of only basic compression LUTs to perform only compression of the gradation is permissible. Further, optionally (for example, when an image with soft-focus finishing is required), expansion of the gradation may be performed using the unsharp image data processed by the LPF 84.

The unsharp image data (luminance image data) processed by the second LUT 86 as described above is supplied to the adder 88. In the adder 88, the primary image data which has been processed by the first MTX 78 and directly sent to the adder 88 and the unsharp image data are added. By this operation, the gradation of the primary image data is compressed (expanded) whereby a similar effect as that obtained by carrying out the dodging technique using areal exposure can be obtained.

In more detail, the unsharp image data which has been processed by the compression LUT in the second LUT 86 becomes image data which is negative value in the bright portion (image data is larger) and positive (plus) value in the dark portion. Therefore, the above-described unsharp image data is added to the primary image data which has been processed by the first MTX 78 whereby the primary image data in the bright portion comes to be small and that in the dark portion comes to be enhanced, that is, the dynamic range of the image data is compressed to correspond to the output density range in the print.

On the contrary, the luminance image data that has been processed by the expansion LUT becomes image data which is positive (plus) value in the bright portion and negative value in the dark portion whereby the above-described luminance image data comes to be added to the primary image data causing expanding the gradation of the image data.

The prescanned data and the fine scanned data in which each dynamic range has been compressed (expanded) by being subjected to the dodging processing in the above-described manner are sent to the data converting subsection 70 and the data converting subsection 74, respectively. It should be noted that an image processing subsection such as a sharpness processing subsection or the like may be provided between the adder 88 and each of the converting subsections.

The data converting subsection 70 of the prescan processing section 56 is a site where the prescanned data processed by the image processing subsection 68 is converted with a 3D (three-dimensional)-LUT or the like to image data corresponding to a representation on the display 20.

On the other hand, the data converting subsection 74 of the fine scan processing section 58 is a site where the fine scanned data processed by the image processing subsection 72 is similarly converted with a 3D (three-dimensional)-LUT or the like to image data corresponding to image recording with the printer 16.

In the processing apparatus 14, the image data processed by the data converting subsection 70 of the prescan processing section 56 and the image data processed by the data converting subsection 74 of the fine scan processing section 58 are sent to the display 20 and the printer 16, respectively.

It should be noted that the display 20 is not particularly limited but various types of known display devices such as a CRT (Cathode Ray Tube), a liquid crystal display and the like can be used.

The printer 16 exposes the light-sensitive material (photographic paper) in accordance with the image data outputted from the fine scan processing section 58 to record a latent image which is subsequently subjected to development processing corresponding to the light-sensitive material to output a (finished) print.

To give one example of the printer's operation, the light-sensitive material is cut to a predetermined length in accordance with the size of the final print; thereafter, the printer records a back print and three light beams for exposure to red (R), green (G) and blue (B) in accordance with the spectral sensitivity characteristics of the light-sensitive material (photographic paper) are modulated in accordance with the image data (recorded image); the three modulated light beams are deflected in the main scanning direction while, at the same time, the light-sensitive material is transported in the auxiliary scanning direction perpendicular to the main scanning direction so as to record a latent image; the latent-image-bearing light-sensitive material is then subjected to wet development processing comprising color development, bleach-fixing, rinsing and the like; the thus processed light-sensitive material is dried to produce a finished print; a plurality of prints thus produced are sorted and stacked.

Hereafter, the present invention will be described in detail by describing an operation of the photoprinter 10.

At the request of print production of the film F, the operator loads the scanner 12 with the carrier that corresponds to the film F, sets the film F in a predetermined position on the carrier, enters necessary commands such as the size of the print to be produced and the like and, thereafter, keys in a command for getting the print production started.

In response to this command, a stop-down value (aperture size) of the variable diaphragm 24 in the scanner 12 or a storage time of the image sensor 34 is set in accordance with the reading condition for prescan and, thereafter, the carrier transports the film F such that the frame to be subjected to the print production is transported to a reading position. Further, when the film F is transported, magnetic information recorded on the magnetic recording medium or the bar code such as the DX code or the like is read and necessary information such as the type of the original, the size of the original (loading information of the carrier is permissible) and the like are sent to a predetermined site such as the selecting part 62a of the setup subsection 62.

Next, the prescan of the frame of interest is started and, as described above, each color filter of the color filter plates 26 is inserted one after another and each projected light is focused on the image sensor 34 so that the image of the frame of interest is separated into three primary colors of R, G and B which are subsequently captured photoelectrically.

Both prescan and fine scan may be performed frame by frame; alternatively, all frames may successively be subjected to prescan and fine scan; if desired, prescan and fine scan may continuously be performed on frame groups each consisting of a given number of frames. On the pages that follow, the case of performing prescan and fine scan frame by frame is described for the sake of simplicity of explanation and clarification of the operation.

The output signals produced from the image sensor 34 by prescan are amplified by the Amp 36 and sent to the A/D converter 38 where they are converted to digital signals.

The digital signals are sent to the processing apparatus 14 where they are subjected to specified data processing in the data processing section 46 thereof, converted to prescanned data in a digital image data form in the log converter 48 and the resultant prescanned data is stored in the prescan memory 50.

When the prescanned data is stored in the prescan memory 50, the setup subsection 62 of the condition setting section 54 reads the thus stored prescanned data, constructs the image density histogram, calculates image characteristic quantities such as highlights, shadows and the like, sets the reading condition for fine scanning the frame of interest and then supplies the thus set reading condition to the scanner 12.

The setup subsection 62, further, sets image processing conditions in the prescan processing section 56 and the fine scan processing section 58 relative to the image (frame) of interest such as the LUT in the first LUT 76, the compression LUT (expansion LUT which is hereinafter omitted from description) in the second LUT or the like in accordance with the image density histogram and the calculated image characteristic quantities, sometimes in combination with optionally entered operator's commands and supplies the thus set image processing conditions to the parameter coordinating subsection 66. Upon receiving the image processing conditions, the parameter coordinating subsection 66 sets them at a predetermined site each in the prescan processing section 56 and the fine scan processing section 58.

As described above, the compression LUT in the second LUT is produced such that the selecting part 62a selects the basic compression LUT from a plurality of stored basic compression LUTs (basic expansion LUTs which are hereinafter omitted from description) in accordance with one or more parameters such as the type of the original, the size of the original, the image analysis result and the operator's command and the like and then the setup subsection 62 produces such compression LUT using the thus selected basic compression LUT in accordance with the image analysis.

When the image processing condition is set, the display 20 turns to verification screen. On this occasion, prescanned data is read from the prescan memory 50 by the prescan processing section 56 and processed with the image processing condition corresponding to the image data in the image processing subsection 68 to produce the image (prescan image) which reproduces the prescanned data which is subsequently represented on the display 20 as a simulation image (anticipated finish-image).

Next, looking at the simulation image represented on the display 20, the operator verifies the image and, if necessary, manipulates the aforementioned keys on the keyboard 18a or the like to adjust the color, density, gradation and other features of the image.

Inputs for these adjustments are sent to the key correcting subsection 64 which, in response to the entered inputs for adjustments, calculates amounts of correction of the image processing conditions and sends them to the parameter coordinating subsection 66.

In response to the supplied amounts of correction, the parameter coordinating subsection 66 corrects the image processing condition set in the prescan processing section 56 and the fine scan processing section 58 or calculates a correction condition for performing any of the above-described adjustments so that it is set in a predetermined position in each of the processing sections. Accordingly, the image represented on the display 20 also varies in response to this corrective measure, or the inputs for adjustment entered by the operator.

If the operator concludes that the image is appropriate (verification OK), the operator gives a command for print start. The image processing conditions are finalized in accordance with this command whereby fine scan gets started. When no image verification is performed, the image processing conditions are finalized at the point of time when the parameter coordinating subsection 66 ends setting of the image processing conditions whereby fine scan gets started.

Fine scan is performed in the essentially same manner as prescan except for the storage time of the image sensor 34 or the stop-down value of the variable diaphragm 24 so that the output signals from the image sensor 34 are amplified by the Amp 36, converted to digital form by the A/D converter 38, processed by the data processing section 46 in the processing apparatus 14, converted to fine scanned data by the log converter 48 and sent to the fine scan memory 52.

Subsequently, the fine scanned data is read from the fine scan memory 52 by the fine scan processing section 58, processed by the image processing condition finalized in the image processing subsection 72, converted to output image data corresponding to the image recording by the printer 16 by the image data converting subsection 74 and sent to the printer 16 where the print is produced.

While the image processing method and apparatus according to the present invention has been described above in detail with reference to various embodiments, it should be noted that the invention is by no means limited to the foregoing embodiments and various improvements and modifications may of course be made without departing from the scope and spirit of the invention.

As described above in detail, according to the present invention, the dodging processing having excellent characteristics which is capable of substantially decreasing the washed-out highlight in the bright portion or the flat (dull) shadow in the dark portion in the scene where the subject is taken with backlight or the electronic flash can be performed in a shorter period of processing time than that in a conventional way whereupon productivity in print production, for example, by the digital photoprinter or the like can advantageously be enhanced.

What is claimed is:

1. An image processing method comprising the steps of:
preliminarily setting a plurality of basic compression characteristics or basic expansion characteristics of image information;
selecting one or more basic compression characteristics or basic expansion characteristics from said plurality of basic compression characteristics or basic expansion characteristics; and
compressing or expanding gradation of said image information using the thus selected one or more basic compression characteristics or basic expansion characteristics.

2. The image processing method according to claim 1, wherein said plurality of basic compression characteristics or basic expansion characteristics are preliminarily set in accordance with at least one of an original type, an original size and an analysis result of said image information.

3. The image processing method according to claim 1, wherein said one or more basic compression characteristics or a plurality of basic expansion characteristics are selected in accordance with at least one of an original type, an original size and an analysis result of said image information.

4. The image processing method according to claim 2, wherein said original type is at least one of a negative film, a reversal film and a black-and-white film, and wherein said original size is at least one of a 135 size, a 240 size and a 120/220 size.

5. The image processing method according to claim 1, wherein said one or more basic compression characteristics or basic expansion characteristics are selected by a manual operation.

6. The image processing method according to claim 1, wherein said basic compression characteristics or basic expansion characteristics are provided as a parameter or a look-up table.

7. The image processing method according to claim 1, further comprising the step of analyzing said image information, wherein the step of compressing or expanding gradation of said image information using said selected one or more basic compression characteristics or basic expansion characteristics comprises the steps of:
setting a processing condition for compressing or expanding the gradation of said image information using said selected one or more basic compression characteristics or basic expansion characteristics in accordance with said analysis result; and
processing said image information in accordance with the thus set processing condition.

8. The image processing method according to claim 1, wherein the step of compressing or expanding the gradation of said image information using said selected one or more basic compression characteristics or basic expansion characteristics comprises the steps of:
setting a processing condition for compressing or expanding the gradation of said image information using said selected one or more basic compression characteristics or basic expansion characteristics by a manual operation; and
processing said image information in accordance with the thus set processing condition.

9. The image processing method according to claim 7, wherein said processing condition is set as a look-up table.

10. An image processing method comprising the steps of:
preliminarily setting a plurality of basic compression characteristics or a plurality of basic expansion characteristics;
selecting one or more basic compression characteristics or one or more basic expansion characteristics from said plurality of basic compression characteristics or said plurality of basic expansion characteristics;
analyzing image information;
setting a processing condition for compressing or expanding gradation of said image information using the thus selected one or more basic compression characteristics or the thus selected one or more basic expansion characteristics in accordance with an analysis result obtained by thus analyzing the image information; and
processing said image information in accordance with the thus set processing condition.

11. An image processing method comprising the steps of:
preliminarily setting a plurality of basic compression characteristics or a plurality of basic expansion characteristics;
selecting one or more basic compression characteristics or one or more basic expansion characteristics from said plurality of basic compression characteristics or said plurality of basic expansion characteristics;
setting a processing condition for compressing or expanding gradation of image information using the thus selected one or more basic compression characteristics or the thus selected one or more basic expansion characteristics by an manual operation; and
processing said image information in accordance with the thus set processing condition.

12. An image processing apparatus comprising:
a selecting device for selecting one or more basic compression characteristics or basic expansion characteristics from preliminarily set plurality of basic compression characteristics or basic expansion characteristics for use in compressing or expanding gradation of image information supplied by an image information supply source; and
an image processing device for compressing or expanding the gradation of said image information using said one or more basic compression characteristics or basic expansion characteristics selected by said selecting device.

13. The image processing apparatus according to claim 12, further comprising:
a setting section for analyzing the image information and setting a processing condition for compressing or expanding the gradation of said image information using said one or more basic compression characteristics or basic expansion characteristics selected by said selecting device in accordance with an analyzing result obtained by thus analyzing the image information, wherein said image processing device processes said image information in accordance with the processing condition set by said setting section.

14. The image processing apparatus according to claim 12, further comprising:
a setting section for setting a processing condition for compressing or expanding the gradation of said image information by a manual operation using said one or more basic compression characteristics or basic expansion characteristics selected by said selecting device, wherein said image processing device processes said image information in accordance with the processing condition set by said setting section.

15. The image processing apparatus according to claim 12, wherein said selecting device selects said one or more basic compression characteristic or basic expansion characteristics in accordance with at least one of an original type of an image as an image information source, an original size of the image as the image information source and an analysis result of said image information.
